(19) United States
(12) Patent Application Publication
(10) Pub. No.: US 2014/0015236 A1
(43) Pub. Date: Jan. 16, 2014

(54) GOLF CLUB HEAD COVER HOLDER FOR MOTORIZED GOLF CARTS

(71) Applicant: Thomas Coble, Indianapolis, IN (US)

(72) Inventor: Thomas Coble, Indianapolis, IN (US)

(21) Appl. No.: 13/547,764

(22) Filed: Jul. 12, 2012

(51) Int. Cl. B60R 11/00; F16M 13/02

(52) U.S. Cl. 280/762; 248/205.1; 248/218.4

(57) ABSTRACT

A golf cart is disclosed with a device for holding a golf club head cover. The device has an arm greater than 3 inches and less than 15 inches in length. The arm has a free end generally opposite the mounting with at least a portion of the arm and the free end pointed in a generally upright direction and adapted to receive and hold a golf club head cover thereover.

### BACKGROUND

The present invention relates to golf club head covers, and more specifically to a device for holding the same on a golf cart.

Golf is a popular sport. Golf club head covers, such as for drivers and other woods, are frequently employed. However, they are also frequently lost or misplaced.

Various devices have been attempted to solve this problem. One category of device tends to be lanyards attached to the golf club cover. These lanyards attach to, for example, a golf club bag. Other devices attach to the golf club bag, holding the golf club cover when it is not on a golf club.

However, while these devices may have enjoyed some use and success, it is my impression that their use is not typically widespread. It is also my impression is either that they do not work very well, or are sufficiently cumbersome not to be used much. Thus, there is a need for improvement in this area.

The present invention provides a simple, yet effective solution to the problem of lost or misplaced golf club head covers.

### SUMMARY

Further forms, objects, features, aspects, benefits, advantages, and embodiments of the present invention will become apparent from a detailed description and drawings provided herewith. The invention is set forth by the claims, and only the claims. Generally, the invention may include one or more of a device for holding golf club head covers. This may include a mounting for mounting to a golf cart and an arm on said mounting. The arm is greater than 3 inches and less than 15 inches in length. It has a free end generally opposite the mounting with at least a portion of the arm and the free end pointed in a generally upright direction and adapted to receive and hold a golf club head cover thereover.

### BRIEF DESCRIPTION OF THE DRAWINGS

FIG. 1 is a perspective view of a golf cart having one example of the invention, albeit without a golf club head cover on it.

FIG. 2 is the arrangement of FIG. 1 showing a golf club head cover on the example of the invention.

FIG. 3 is a perspective detail, shown in isolation, of the device of FIGS. 1 and 2.

FIG. 4 is yet another alternative example of the present invention.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

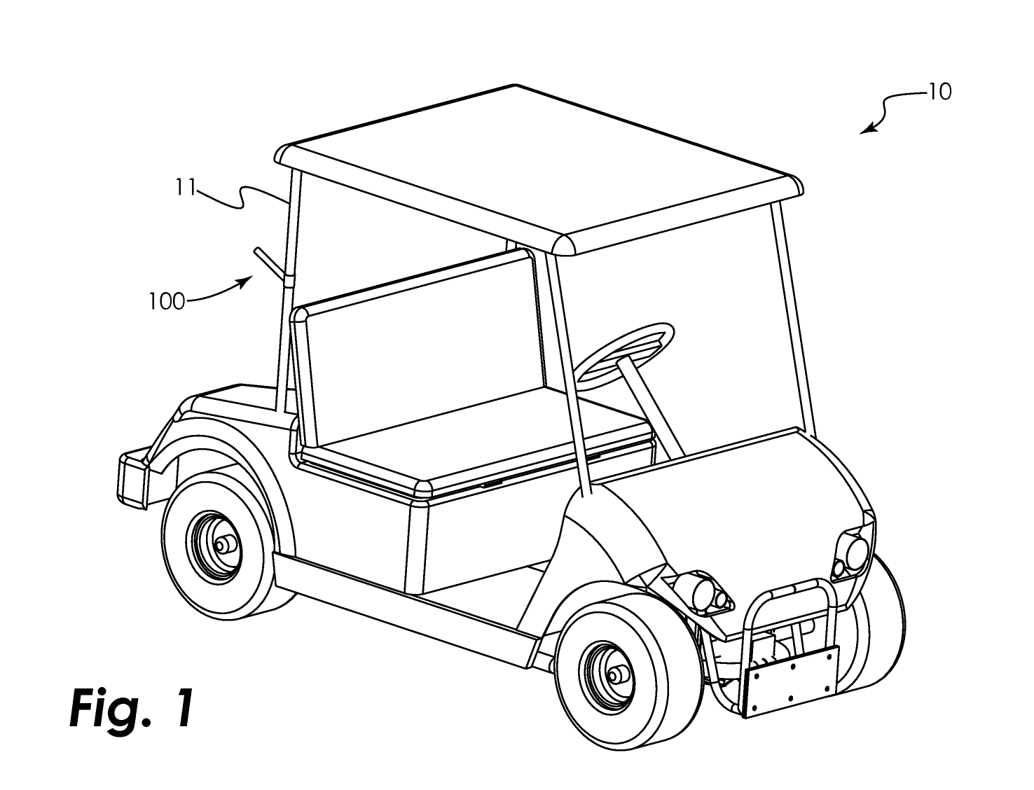

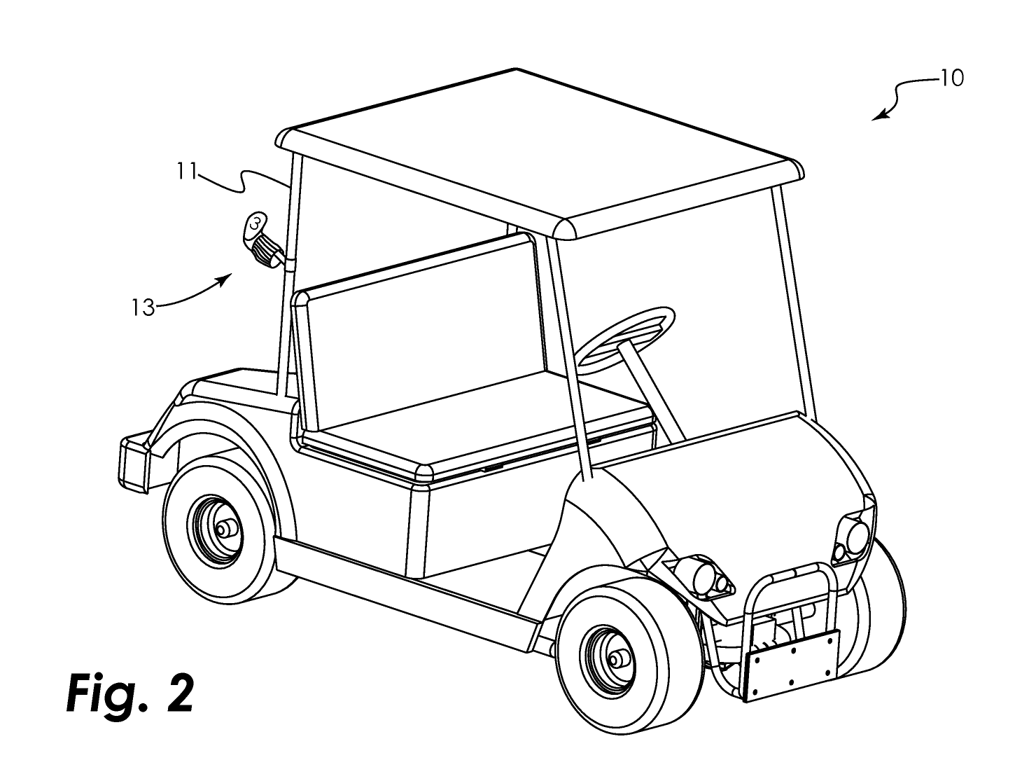

FIGS. 1 and 2 show a golf cart 10. The golf cart 10 includes several vertical uprights to hold the canopy over the passenger area. Those include, for example, vertical upright 11. The device for holding golf club head covers 100 is shown in FIG. 1. In FIG. 2, a golf club head cover 13 is shown mounted on device 100.

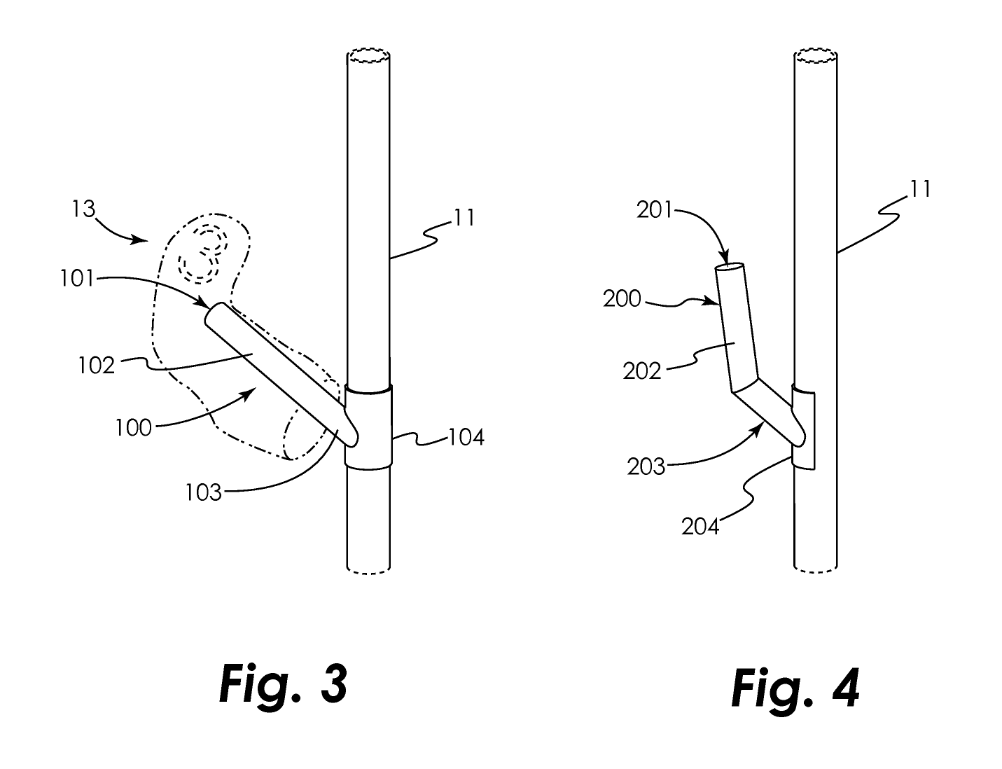

FIG. 3 shows the foregoing in greater detail, with vertical upright 11 and device 100, with golf club cover 13 shown in phantom lines. Device 100 includes an upper arm 102 with a free end 101. Golf club cover 13 is such that free end 101 is generally opposite a mount 104 with at least a portion of the arm 102 and the free end 101 pointed in a generally upright direction and adapted to receive and hold a golf club head cover 13 thereover. Note that mounting 104 may be one of several designs. For example, may be a sleeve over and/or around (fully or partially around) upright 11. It may be a clamp or strap (metal, plastic, fabric, or otherwise). It may be attached by friction, adhesive, screws, welding, hook and loop, integrally formed with 11, or any combination thereof. Optionally, device 100 may include a lower arm segment 103 near the mounting.

FIG. 4 shows another example of the present invention as device 200 which the total arm is not straight. It has a mount 204, which is shown as a plate version of one of the aforementioned variations on mount 104 (FIG. 3). Device 200 has a free end 201 as previously described. Device 200 has an upper arm segment 202 and a lower arm segment 203. There is a bend between those segments in this version. There is preferrably a gap between the arms 102 or 202 and the upright 11 allowing the cover 13 to slide down on the arm and between the arm and the upright or other part of the golf cart.

Preferably, the arm 102 and/or 103; 202 and/or 203 is greater than 3 inches (and more preferably more than 6 inches) in length and less than 15 inches (and more preferably less than 12 inches) in length. Such lengths are measured from the free end to the mount.

Note further that FIGS. 3 and 4 are merely examples. Other arrangements are possible. These include, as contrast with FIG. 4, an arrangement where arm segment 202 is vertical and/or parallel with upright 11. They also may be modified to include curvilinear segments alone or in combination with linear segments or otherwise. Moreover, instead of being a single arm, as illustrated in FIGS. 3 and 4, the device may comprise two or more arm segments projecting generally parallel with each other, including, for example, arm segments that double back on each other at a bend forming the free end. The device may be made of any suitable material, including without limitation, plastic, metal, or otherwise, or a combination thereof.

The device may be retrofitted onto a golf cart, or may be included as part of an originally manufactured golf cart. There may be one, two or more such devices on each golf cart. As indicated, preferably they are attached to a vertical upright of the golf cart, but they may be attached to other portions such as the canopy, basket, horizontal struts, body portions, or otherwise. They may be pointed in any direction so long as the free end is pointed in a generally upright direction (to take advantage of gravity) to hold the golf club head cover. With that in mind, it is generally preferable, but not required to have the devices not point sidewise or laterally to the golf cart in a way to increase the overall width of the golf cart. It is also preferable, but not required, that the device not be positioned low enough or point in the direction such that a passenger in the golf cart might hit their head on them. Safety features, such as rounded edges and the like are preferable, but not required.

Optionally, one may include a single device, with a single mounting to an upright which has two or more arms pointed in a generally upright direction, so as to be able to hold more than one golf club head cover.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A device for holding a golf club head cover, comprising:
a mounting means for mounting to a golf cart;
an arm on said mounting means, said arm being greater than 3 inches and less than 15 inches in length; and,
said arm having a free end generally opposite said means for mounting with at least a portion of said arm and said free end pointed in a generally upright direction and adapted to receive and hold a golf club head cover thereover.

2. The device of claim 1 wherein said mounting means is adapted to retrofit on a golf cart.

3. The device of claim 2 wherein said mounting means is adapted to retrofit on a vertical upright holding a canopy of golf cart.

4. The device of claim 3 wherein said arm is straight.

5. The device of claim 3 wherein said arm is not straight.

6. The device of claim 1 in combination with a golf cart.

7. The device of claim 3 in combination with a golf cart.

8. The device of claim 1 in combination with a golf club head cover over said free end of said arm.

9. The device of claim 3 in combination with a golf club head cover over said free end of said arm.

10. The device of claim 1 wherein said arm being greater than 6 inches and less than 12 inches in length.

11. The device of claim 3 wherein said arm being greater than 6 inches and less than 12 inches in length.

12. The device of claim 6 wherein said arm being greater than 6 inches and less than 12 inches in length.
